(19) United States
(12) Patent Application Publication
(10) Pub. No.: US 2026/0225930 A1
(43) Pub. Date: Aug. 6, 2026

(54) Waste Water Treatment by the Cleanbox Module

(71) Applicant: Pallavi Dnyaneshwar Phadatare, Pune (IN)

(72) Inventors: Pallavi Dnyaneshwar Phadatare, Pune (IN); Dnyaneshwar Dattatray Phadatare, Pune (IN)

(21) Appl. No.: 19/150,879

(22) PCT Filed: Jun. 19, 2023
(86) PCT No.: PCT/IN2023/050584

§ 371 Date: Jul. 24, 2025

(30) Foreign Application Priority Data
Jan. 26, 2023 (IN) 202321005232

(51) Int. Cl. C02F 3/10; C02F 3/06; C02F 3/28

(52) U.S. Cl. CPC C02F 3/109; C02F 3/06; C02F 3/2826

(57) ABSTRACT

The treatment system includes box (4) through which wastewater being re-circulated and one drive section for providing re-circulation of the wastewater through the treatment box. The treatment box (4) includes zigzag arrangement of the plastic or steel plate or cloth (5) constituting the zigzag flowing route (3) of the wastewater and at least one carrier medium (6) where film being grown thereon, complementing the shape of the internal volume of the zigzag configuration plate or cloth and/or occupying at least part of the internal volume of the box. The waste water will enter from one side (1) and treated waste water will come out from the other side (2) of the box.

The space created (3) by the zigzag plate or cloth (3) will be used to put carrier medium (6) and treat the waste water.

### FIELD OF INVENTION

This invention relates to Attached or suspended growth Fixed or Suspended film aerobic or anaerobic activated sludge process of waste water treatment system.

### BACKGROUND

Waste water generated from the various sources shall be treated at the point of the discharge because it causes the threat to environment by polluting the raw water sources.

The principal objective of wastewater treatment is generally to allow human and industrial effluents to be disposed of without danger to human health or unacceptable damage to the natural environment. Irrigation with wastewater is both disposal and utilization and indeed is an effective form of wastewater disposal (as in slow-rate land treatment). However, some degree of treatment must normally be provided to raw municipal wastewater before it can be used for agricultural or landscape irrigation or for aquaculture. The quality of treated effluent used in agriculture has a great influence on the operation and performance of the wastewater-soil-plant or aquaculture system. In the case of irrigation, the required quality of effluent will depend on the crop or crops to be irrigated, the soil conditions and the system of effluent distribution adopted. Through crop restriction and selection of irrigation systems which minimize health risk, the degree of pre-application wastewater treatment can be reduced.

The most appropriate wastewater treatment to be applied before effluent use in agriculture is that which will produce an effluent meeting the recommended microbiological and chemical quality guidelines both at low cost and with minimal operational and maintenance requirements. Adopting as low a level of treatment as possible is especially desirable in developing countries, not only from the point of view of cost but also in acknowledgement of the difficulty of operating complex systems reliably. In many locations it will be better to design the reuse system to accept a low-grade of effluent rather than to rely on advanced treatment processes producing a reclaimed effluent which continuously meets a stringent quality standard.

There are various methods to treat wastewater using a combination of physical, chemical and biological treatment processes. A conventional treatment combination is to subject the wastewater to a physical pre-treatment and then to a biological one as a second stage of process. Conventional aerobic and anaerobic processes are very common for municipal wastewater treatment and they are considered effective technical solutions for environmental protection in terms of construction and operational costs for large units. In contrast, when large areas have to be serviced, while it is not possible to design a central treatment unit but many smaller ones, conventional systems are not the most appropriate choice

The domestic wastewater treatment systems where smaller volumes of wastewater are treated use various types of tanks for treatment operations. In these systems, the carrier materials are placed in the tank (fixed or moving). Since the surface area of the bio pack media affects significantly the efficiency of the treatment process, these large tanks are required and which leads to great space and volume required. Further to that, as tanks are difficult to transport and install, it is not so practical to replace or perform maintenance operations of the tanks. Besides, the tank cannot be replaced whenever the volume of wastewater to be treated changes. Therefore, there is still a need of development for those wastewater treatment systems which will save space losses and high costs of production and operation and provide a high performance treatment.

There are some inventions where waste water is treated by new structural design like pipe (US publication no US 2015/0175453 A1). In the method waste water is treated through the pipe which is filled with the bio media. And it proves following advantages against the conventional waste water treatment methods.

1. Low foot prints 2. Low energy consumption 3. Flexible and modular design 4. Low operation and maintenance cost. 5. Virtually silent method.

### OBJECTS IN THE INVENTION

A main objects of the invention are as below
1. To provide an innovative waste water treatment unit which will consume very less electricity compared with current treatment technologies.
2. To provide compact waste water treatment unit to reduce area losses
3. To reduce operation and maintenance cost.
4. To provide economical or cost effective waste water treatment unit
5. To provide easy handling waste water treatment unit
6. To reduce the equipments erection cost

### STATEMENT OF INVENTION

The treatment includes outer box with inside zigzag configuration plates or cloth or plates with alternate top and bottom holes to creates zigzag wastewater flow route or up and down flow route between the plate end and outer box.

With The air inlet vent the system can be aerobic and without air inlet vent the system can be anaerobic. So as per waste water characteristics the system can treat the wastewater by aerobically or an-aerobically or by combination of both i.e. anaerobic followed by the aerobic system or vice versa. In both the cases inside media filling is required.

### A SUMMARY OF INVENTION

The method and system or unit for treating wastewater by a fixed or suspended growth bio-film process is mentioned. The treatment includes outer box with inside zigzag configuration plates or cloth or plates with alternate top and bottom holes. It creates zigzag wastewater flow route between the plate end and outer box to put the carrier medium where bio-film being grown thereon.

The space created by the zigzag plate or cloth will be used to put bio medium and treat the waste water. The nozzles for natural air or external air supply will be provided for the aeration purpose in case of the aerobic system and there will not be air inlet for the anaerobic system.

### A BRIEF DESCRIPTION OF THE ACCOMPANYING DRAWING

The accompanying drawings are included to provide a further understanding of the present disclosure, and are incorporated in and constitute a part of this specification. The drawings illustrate exemplary embodiments of the present disclosure and, together with the description; it will serve to explain the principles of the present disclosure.

The diagrams are for illustration only, which thus is not a limitation of the present disclosure, and wherein:

FIG. 1 illustrates the schematic isometric arrangement of the plate to form a cleanbox module in accordance with the present invention.

FIG. 2 illustrates a side view of the cleanbox module in accordance with the present invention.

FIG. 3 illustrates a sectional side view of the cleanbox module in accordance with the present invention.

### DETAILED DESCRIPTION OF DRAWINGS

The following is a detailed description of the accompanying drawings. The given details are such a way that it will clearly communicate the disclosure. However, the amount of detail offered is not intended to limit the anticipated variations of embodiments; on the contrary, the intention is to cover all modifications, equivalents, and alternatives falling within the scope of the present disclosure.

In the following description, numerous specific details are set forth in order to provide a thorough understanding of the modular arrangements of the present invention. It will be apparent to one skilled in the art that embodiments of the present invention may be practiced without some of these specific details.

Various terms as used herein are shown below. To the extent a term used, it should be given the broadest definition persons in the pertinent art have given that term as reflected in printed publications and issued patents at the time of filing.

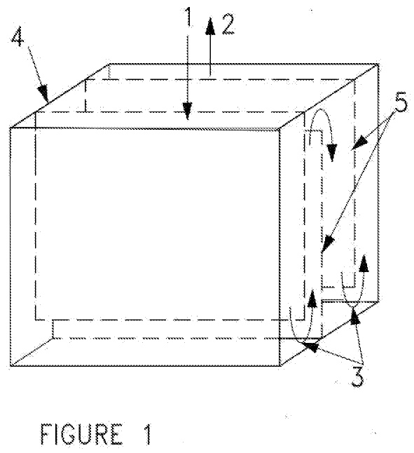

Below provided are the figure wise reference numerals used for respective components as shown in the FIGS. 1-3:

FIG. 1 shows the arrangement of the plate inside the cleanbox module, wherein:
1 denotes: Waste water entry for the cleanbox
2 denotes: Waste water outlet of the cleanbox
3 denotes: Wastewater flow zigzag route
4 denotes: Outer box
5 denotes: Zigzag plates

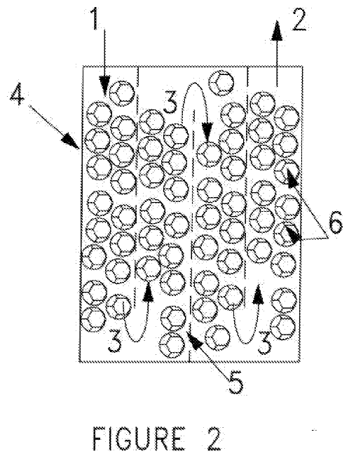

FIG. 2 shows the side view of the cleanbox module,

wherein:
1 denotes: Waste water entry for the cleanbox
2 denotes: Waste water outlet of the cleanbox
3 denotes: Wastewater flow zigzag route
4 denotes: Outer box
5 denotes: Zigzag plates
6 denotes: Carrier medium for biofilm growth

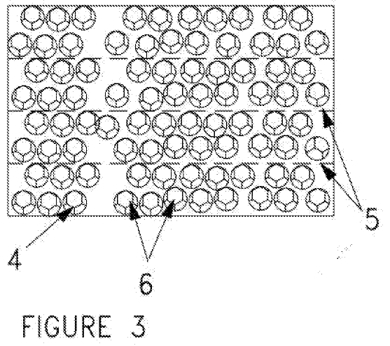

FIG. 3 shows the sectional side view of the cleanbox module

wherein:
4 denotes: Outer box
5 denotes: Zigzag plates
6 denotes: Carrier medium for biofilm growth

The present invention is related to a wastewater treatment unit and method in order achieve the objectives mentioned above and to bring the advanced technology to the related technical field. The major objective of this invention is to provide a wastewater treatment system or unit which will reduce the high costs of erection, operation and maintenance. Also to reduce the significant space consumption and which will be user friendly at varying conditions.

In addition to above, further objective of this invention is to provide a wastewater treatment unit and method which will reduce the environmental pollution with high efficiency compared with current wastewater treatment technologies.

In order to realize all of the above-mentioned objects and the objects which are to be obtained from the detailed description, the present invention is related to a treatment unit in which the wastewater is treated by means of attached or suspended bio-film process.

The treatment system includes at least one box (4) formed by the inside zigzag arranged steel plate (5) through which wastewater will flow. The treatment box includes outer box (4) with inside zigzag configuration plates (5) or cloth or plates (5) with alternate top and bottom holes. It creates zigzag wastewater flow route (3) between the plate end (5) and outer box (4) to put the carrier medium (6) where bio-film being grown thereon occupying at least part of the internal volume of the box (4). Or up and down flow route (3) between the plate end (5) and outer box (4) to put the carrier medium (6)

The space created by the zigzag arranged plate (4) will be used to put bio medium (6) and treat the waste water. The nozzles for natural air or external air supply will be provided for the aeration purpose.

Following are the theoretical parameters comparison between the various conventional waste water treatment systems and the bio drum system

| | | Sequencing | | | Rotating | |
|---|---|---|---|---|---|---|
| | | Batch | Membrane | Moving bed | Biological | |
| Sr. | | Reactor | Bioreactor | Bioreactor | Contactor | Cleanbox |
| No. | Parameter | (SBR) | (MBR) | (MBBR) | (RBC) | system |
| 1 | Footprint | Moderate | Low | Low | Low | Low because of |
| | | | | (depends on | | the less |
| | | | | media fill | | equipments |
| | | | | factor in | | required |
| | | | | MBBR tank, | | |
| | | | | type of liquid | | |
| | | | | solid | | |
| | | | | separation | | |
| | | | | unit e.g. | | |
| | | | | settling tank | | |
| | | | | versus DAF | | |
| | | | | unit etc.) | | |
| 2 | Control | Simple | Complicated | Simple | Simple | Simple |
| 3 | Electricity | High | High | Moderate | Moderate | Low because of |
| | consumption | | | | | the less |
| | | | | | | equipments |
| | | | | | | required like air |
| | | | | | | blower, sludge |
| | | | | | | settling system |
| | | | | | | etc |
| 4 | Operation | High | High | Moderate | Moderate | Low because of |
| | and | | | | | the less |
| | Maintenance | | | | | equipments |
| | | | | | | required |
| 5 | Equipment | High | High | Moderate | Moderate | Low because of |
| | installation | | | | | the compact |
| | cost | | | | | system i.e. the |
| | | | | | | less equipments |
| | | | | | | used |
| 6 | System cost | High | High | Moderate | Moderate | Low because of |
| | | | | | | the compact |
| | | | | | | system i.e. the |
| | | | | | | less equipments |
| | | | | | | used |

I claim:

1. A CLEANBOX consists of at least one box (4) with inside zigzag plates (5);
wherein a plate (5) made from the plastic or cloth or steel is arranged in the zigzag configuration by keeping the required space between the plate end (5) and outer box (4) resulted in the formation of a rectangular or circular cross-section passage or up and down flow route (3);
bio media (6) placed in this rectangular passage;
the waste water is admitted to the said cleanbox through the waste water entry passage (1) and further passing through the bio materials (6) placed in the rectangular passage, wherein the bio-film is grown and the waste water is cleaned as it passes towards the waste water outlet passage (2) and this cleaned or treated water is further sent for the further use or discharge in the environment;
